(19) United States
(12) Patent Application Publication
(10) Pub. No.: US 2026/0117844 A1
(43) Pub. Date: Apr. 30, 2026

(54) NON-BACKDRIVABLE SELF-LOCKING GEAR SYSTEM INCLUDING ONE OR MORE HELICAL GEARS

(71) Applicant: Kinatech, LLC, Syracuse, NY (US)

(72) Inventors: Stephen John Kochan, Skaneateles, NY (US); William McVea, Syracuse, NY (US); Dean J. Burrows, Syracuse, NY (US); Jeffrey A. Rynders, Syracuse, NY (US)

(73) Assignee: Kinatech, LLC, Syracuse, NY (US)

(21) Appl. No.: 19/008,315

(22) Filed: Jan. 2, 2025

Related U.S. Application Data
(60) Provisional application No. 63/616,877, filed on Jan. 2, 2024.

(51) Int. Cl. F16H 1/28; F16H 35/00; F16H 55/16; F16H 55/17

(52) U.S. Cl. CPC F16H 1/28; F16H 55/16; F16H 2035/005; F16H 2055/178

(57) ABSTRACT

The present invention is directed to a self-locking non-backdrivable gear system. The gear system may comprise a primary motor input and self-lubricating gear box. The primary motor input is for rotation of the gearbox about the axis of a drive shaft. The gearbox may comprise an input ring gear, one or more helical balance gears, fixed helical gear, and output helical gear. In operation, rotation of the primary motor input causes rotation of the ring gear which causes rotation of the helical balance gears, which causes rotation of the output helical gear, which causes rotation of the drive shaft. However, in the absence of rotation of the ring gear, a rotational force applied to the output helical gear causes the gear teeth on the fixed and output helical gears to lock the helical balance gear in place.

### CROSS-REFERENCE TO RELATED APPLICATIONS

This application claims the benefit and priority to U.S. Provisional Patent Application No. 63/616,877, filed on Jan. 2, 2024, and is related to U.S. patent application Ser. No. 17/948,819 filed on Sep. 20, 2022, now U.S. Pat. No. 11,859,700,F which claims priority to U.S. patent application Ser. No. 16/826,843 filed on Mar. 23, 2020, now U.S. Pat. No. 11,448,297, which claims priority to, and the benefit of U.S. patent application Ser. No. 16/589,821 filed on Feb. 10, 2017, now U.S. Pat. No. 10,451,155, which, in turn, claims priority to and the benefit of U.S. Provisional Patent Application No. 62/294,693 filed Feb. 12, 2016. The entire contents of such applications are hereby incorporated herein by reference.

### BACKGROUND OF THE INVENTION

The present invention generally relates to the field of gear design, and more particularly relates to gear systems, which are self-locking and non-backdrivable, and even more particularly relates to a self-locking and non-backdrivable helical gear system.

Modern post-industrial society hinges on the ability to move and stop at will. With the emergence of sophisticated control modeling software, a need has arisen for the precise ability to stop and move machinery to known positions safely. Whether it is a robotic arm on the assembly-line floor, a numerically controlled milling machine that mills aluminum into intricate finished products or a 3D printer for creating plastic prototypes, machines must move in a known and repeatable manner. Machinery that moves in close proximity to people must additionally have the ability to move with great safety. The present invention may be implemented into machinery to allow for such mechanical movements.

### SUMMARY OF THE INVENTION

Aspects of the present disclose are directed to a self-locking non-backdrivable gear system including a gearbox, a primary motor input, and a drive shaft extending along an axis and operatively coupled to the primary motor input. The drive shaft is configured to drive a rotation of the gearbox about the axis of said drive shaft. In some embodiments, the gearbox includes an input ring gear mounted around said drive shaft and positioned in rotational engagement with the primary motor input. In some embodiments, a ring plate and seal configuration are mounted to the input ring gear and configured for sealing components within the input ring gear. In some embodiments, at least one helical balance gear rotatably mounted within the input ring gear and configured to rotate about a mounting axis. In some embodiments, the at least one helical balance gear is further configured to rotate with the input ring gear. In some embodiments, an output helical gear is rotatably mounted within the input ring gear in a radially inward, concentric relation to the input ring gear and comprises a first predetermined number of gear teeth in meshing engagement with the at least one helical balance gear. In some embodiments, an output shaft is connected to the drive shaft. In some embodiments, a fixed helical gear is fixedly mounted around the output shaft and positioned adjacent to the output helical gear. In some embodiments, the fixed helical gear comprises a second predetermined number of gear teeth in meshing engagement with the at least one helical balance gear, wherein the first predetermined number and the second predetermined number are different. In some embodiments, the teeth of the fixed helical gear and the output helical gear engage oppositely oriented teeth of the at least one helical balance gear. In some embodiments, rotation of the primary motor input causes rotation of the input ring gear, which causes rotation of the at least one helical balance gear which causes rotation of the output helical gear which causes rotation of the drive shaft. In some embodiments, in the absence of rotation of the input ring gear, a rotational force applied to the output helical gear forces the teeth of the fixed and output helical to lock the at least one helical balance gear in place.

In some embodiments, the at least one helical balance gear includes a first gear portion and a second gear portion. In some embodiments, the first gear portion includes a first plurality of gear teeth arranged in a first orientation and the second gear portion includes a second plurality of teeth arranged in a second orientation that is different than the first orientation. The first orientation and the second orientation include one of a right-hand orientation and a left-hand orientation. In some embodiments, the first gear portion includes a first diameter, and the second gear portion includes a second diameter that is different than the first diameter.

In some embodiments, the fixed helical gear includes a fixed gear diameter and output helical gear includes an output gear diameter that is different from the fixed gear diameter. In some embodiments, the fixed helical gear is configured to engage one of the first and second gear portions of the at least one balance helical gear, and the output helical gear is configured to engage another of the first and second gear portions of the at least one helical balance gear. In some embodiments, the first gear portion and the second gear portion define similarly sized diameters. In some embodiments, the fixed helical gear teeth and the output helical gear teeth include a noise-dampening pressure angle configuration which angularly compliments the teeth of the at least one helical balance gear. In some embodiments, the gear system further includes a modifying device positioned between the first gear portion and the second gear portion. In some embodiments, the modifying device includes a buffering clutch configured to smooth gear engagement.

In some embodiments, the gear system further includes at least one bearing positioned proximate to the at least one helical balance gear and configured to counter an axial thrust load generated by the at least one helical balance gear. In some embodiments, the gear system further includes at least one bearing positioned proximate to the helical output gear configured to counter an axial thrust load generated by the helical output gear.

Additional objects, advantages and novel features of the present invention will be set forth in part in the description which follows and will in part become apparent to those in the practice of the invention, when considered with the attached figures.

### BRIEF DESCRIPTION OF DRAWINGS

The accompanying drawings form a part of this specification and are to be read in conjunction therewith, wherein like reference numerals are employed to indicate like parts in the various views.

FIG. 1 is a perspective view of an embodiment of the present invention.

FIG. 2 is a side, perspective of the present invention.

FIG. 3 is an exploded, top, plan view of certain features of the present invention.

FIG. 4 is an exploded, top, perspective view of the present invention.

FIG. 5 is an exploded, perspective view of the present invention.

FIG. 6 is a front, cross-sectional, plan view of the gearbox of the present invention, taken across line 6-6 of FIG. 3.

FIG. 7 is a cross-sectional, top, plan view of the gearbox of the present invention, taken across line 7-7 of FIG. 3.

FIG. 8 is an enlarged, schematic, fragmented, plan view showing an embodiment of a gear teeth engagement of the present invention.

FIG. 9 is a front view showing an embodiment of the connection between the motor and ring gear.

FIG. 10 is a front view showing another embodiment of the connection between the motor and ring gear.

FIG. 11 is a front view showing another embodiment of the connection between the motor and ring gear.

FIG. 12 is a front view showing another embodiment of the connection between the motor and ring gear.

FIG. 13A illustrates a side, perspective view of an embodiment of a spur gear and a balance gear, each having gear teeth at a zero-helix angle.

FIG. 13B illustrates a side, perspective view of an embodiment of a helical gear and a helical balance gear, each having gear teeth at opposite helix orientations.

FIG. 14 illustrates a side, perspective view of an embodiment of a helical balance gear having a first gear portion and a second gear portion.

FIG. 15 illustrates a side, perspective view of an embodiment of two helical balance gears each mating with helical mating gears having oppositely oriented gear teeth.

FIG. 16A illustrates an embodiment a helical balance gear with first and second gear portions interacting with corresponding first and second gear portions of an embodiment of the output helical gear.

FIG. 16B illustrates an embodiment of a helical balance gear with first and second gear portions interacting with corresponding embodiments of the fixed helical gear and the output helical gear.

FIG. 17 illustrates a side, perspective view of three different gears illustrating the difference between gear teeth orientation for spur gears and helical gears.

FIG. 18 illustrates vector force representations of two helical gears working to cancel thrust force as a function of applied torque.

FIG. 19 schematically illustrates another vector representation of two helical gears working to cancel thrust force as a function of applied torque.

FIGS. 20 (A)-(C) illustrates various types of helical gear interactions.

FIG. 21 illustrates an embodiment of a balance gear with two portions of different sizes or an interaction between two separate balance gears of different sizes.

### DETAILED DESCRIPTION OF THE INVENTION

The following discussion relates to various embodiments of a non-backdrivable self-locking gear system comprising one or more helical gears. It will be understood that the herein described versions are examples that embody certain inventive concepts as detailed herein. To that end, other variations and modifications will be readily apparent to those of sufficient skill. In addition, certain terms are used throughout this discussion in order to provide a suitable frame of reference with regard to the accompanying drawings. These terms such as “upper”, “lower”, “forward”, “rearward”, “interior”, “exterior”, “front”, “back”, “top”, “bottom”, “inner”, “outer”, “first”, “second”, and the like are not intended to limit these concepts, except where so specifically indicated. The terms “about” or “approximately” as used herein may refer to a range of 80%-125% of the claimed or disclosed value. The term “similar” refers to two values or configurations as being approximate in shape and/or size. With regard to the drawings, their purpose is to depict salient features of the non-backdrivable self-locking gear system comprising one or more helical gears and are not specifically provided to scale.

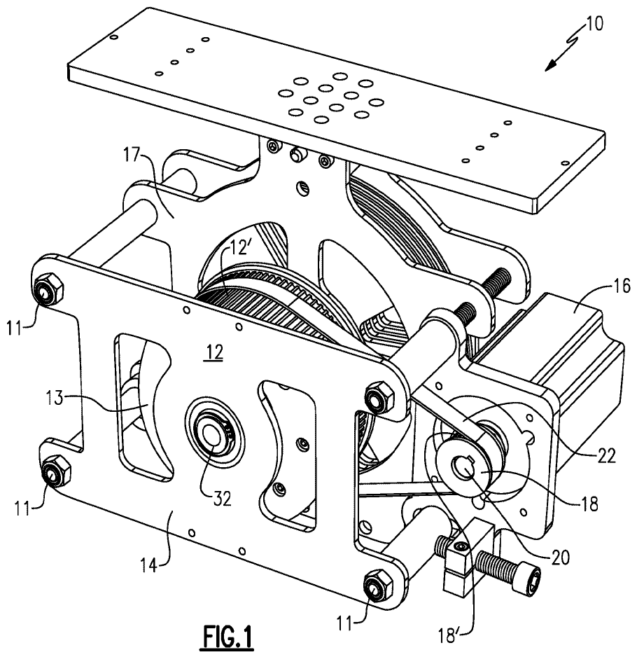

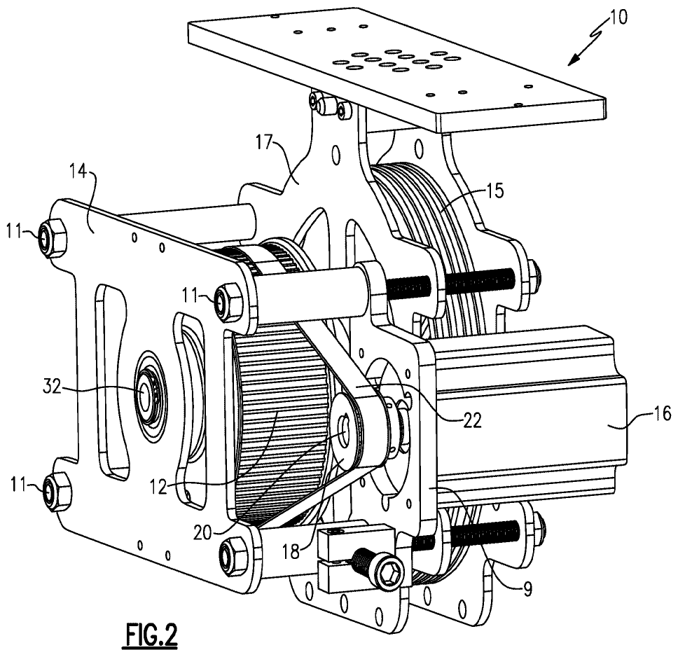

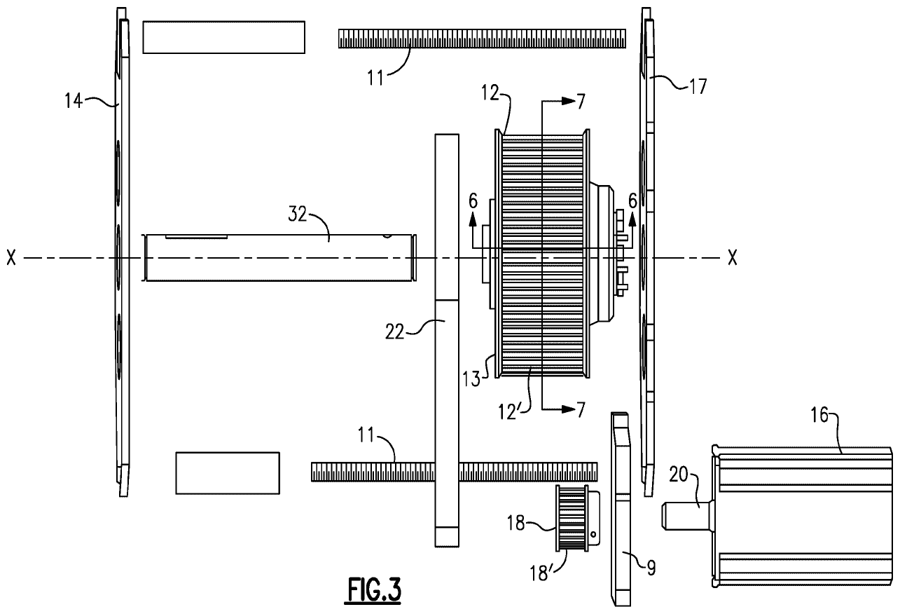

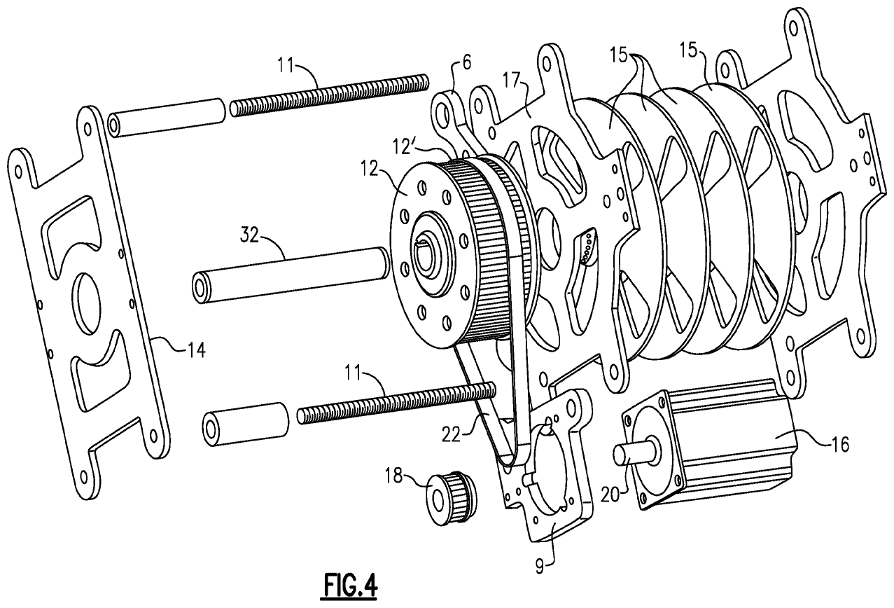

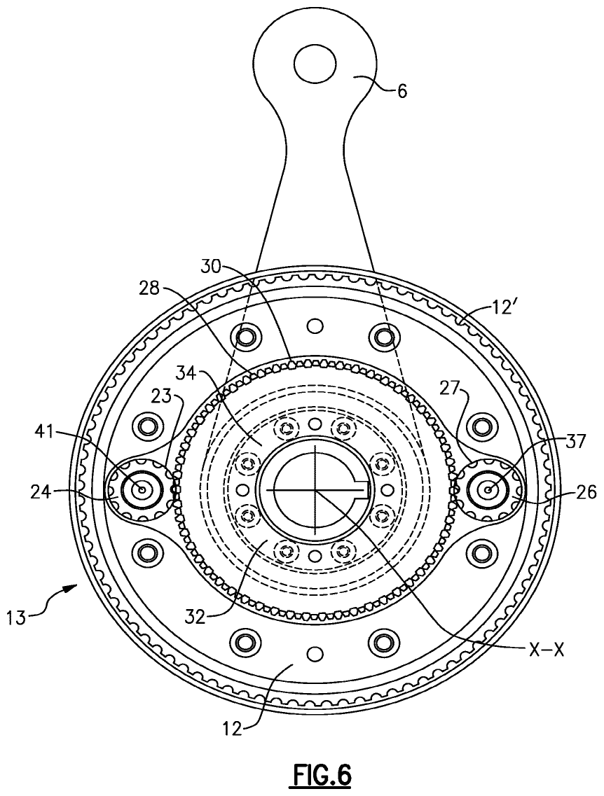

Referring now to the drawings, there is seen in FIGS. 1 through 4 a prior art version of a non-backdrivable self-locking gear system embodiment referred to herein as the “output ring gear system” and indicated generally by the reference numeral 10. This embodiment has a cylindrical gear, such as a fixed spur gear and output cylindrical gear arrangement (e.g., an output spur gear arrangement) in a gearbox 13 configuration and mounted to a back plate 17 via a mount paddle 6 (FIG. 6). As shown, the spur gear 28, 30 comprises a plurality of gear teeth at a zero helix angle. Back plate 17 abuts a winch 15 on one side and on the other side may be connected to a gear support plate 14 through a series of bolts 11. Gear support plate 14 supports and substantially protects gearbox 13 from the surrounding environment during operation. Output ring gear system 10 may also be mounted within a cast or fabricated box for safety purposes and/or conventionality.

An input motor 16 or a motor is mounted to a motor plate 9. Motor 16 rotates a sprocket 18 via shaft 20. Sprocket 18 rotates a timing belt 22 that, in conjunction with the input motor 16, sprocket 18, and shaft 20, makes up the primary motor input of the output ring gear system 10. A plurality of teeth on the underside of timing belt 22 mesh with the teeth 18′ of sprocket 18 and the teeth 12′ on the external side of an input ring gear 12 of a gearbox 13, which is mounted to a drive shaft 32 of gear system 10. Drive shaft 32 connects to winch 15 on which a cord connected to a load may be wound (not shown).

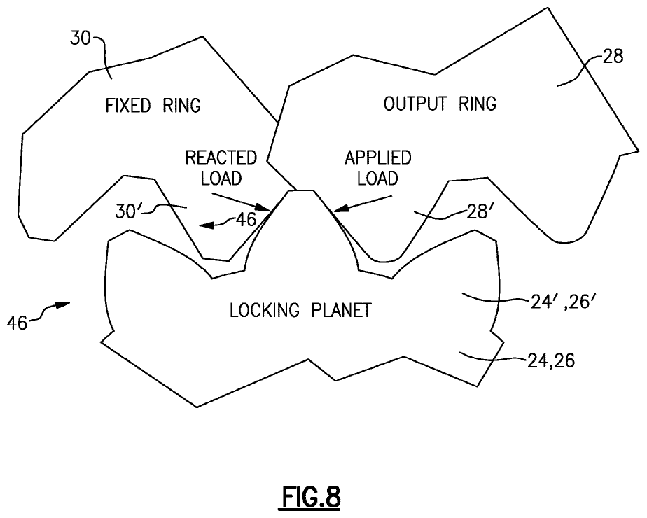

When shaft 20 rotates sprocket 18, timing belt 22 causes input ring gear 12 to rotate around the longitudinal axis X-X of the drive shaft 32 (FIG. 6) in a synchronous relationship with shaft 20. Rotating input ring gear 12 in this manner may effectively be quieter than rotating input ring gear 12 by other previously-known configurations (e.g., a sun gear connected to input ring gear 12 or any internal components therein) known to generate substantial amounts of mechanical noise. Rotation of input ring gear 12 moreover causes the internal components (discussed below) of gearbox 13 to rotate. In other embodiments of output ring gear system 10, timing belt 22 may be a timing chain or a plurality of timing gears (interposed between sprocket 18 and input ring gear 12). For example, FIG. 9 illustrates a double sided polymer timing belt 122 which may be metal reinforced (e.g., steel or KEVLAR) in meshing engagement with sprocket 18 and input ring gear 12.

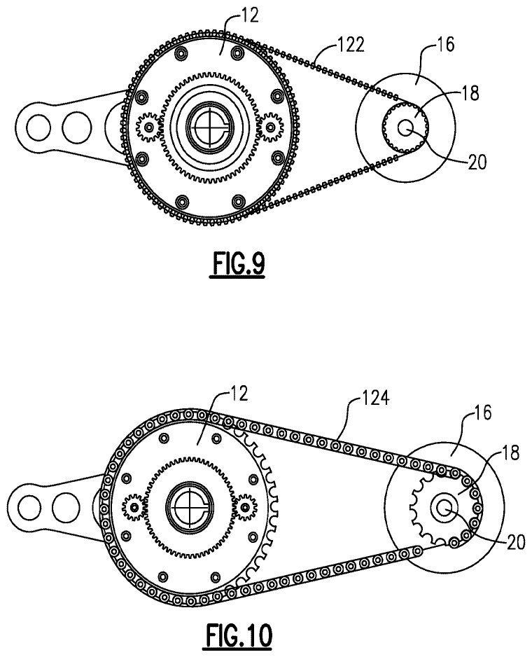

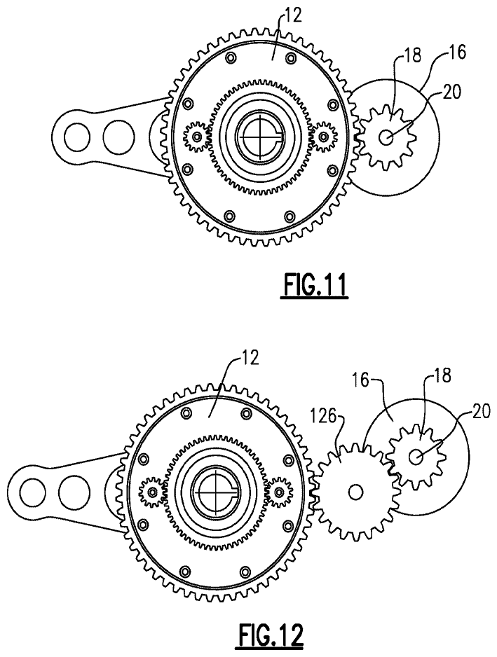

In another embodiment seen in FIG. 10, a roller chain timing belt 124 is in meshing engagement with sprocket 18 and input ring gear 12. In yet another embodiment seen in FIG. 11, sprocket 18 is in direct meshing engagement with input ring gear 12. In still another embodiment seen in FIG. 12, at least one timing gear 126 is in meshing engagement with sprocket 18 and input ring gear 12. Other gear system 10 embodiments may be configured to comprise a plurality of input ring gears 12, positioned such that each may be driven by a single primary motor input (e.g., timing belt, sprocket, and motor configuration).

It should be appreciated that motor 16 may, for example, be a NEMA (National Electrical Manufacturers' Association) “C-Faced” motor. However, motor 16 may also be replaced with a manual operation device (e.g., crank and lever configurations) for rotation of the sprocket 18 via shaft 20. It should be further understood that the primary motor input may be embodied to comprise other components and configurations (e.g., pinion, annular gear, etc.). Other embodiments of gear system 10 may even further include multiple motor inputs.

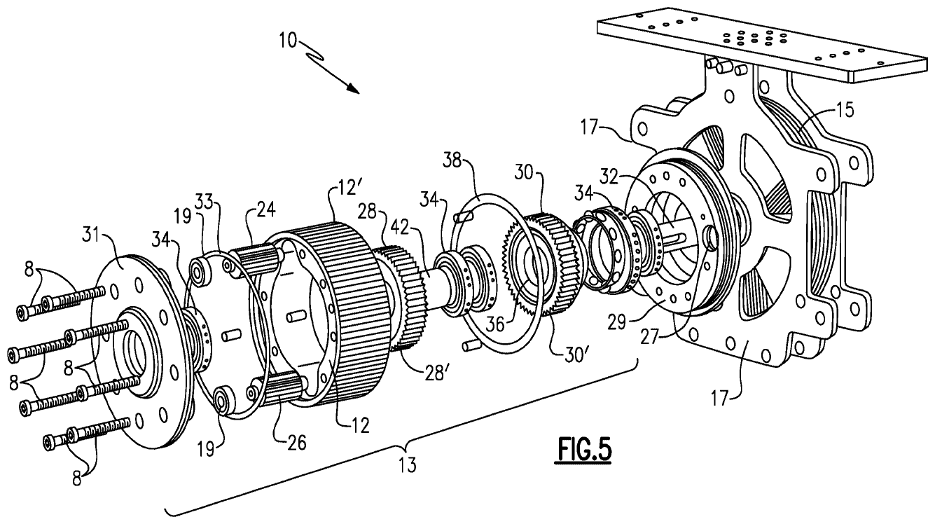

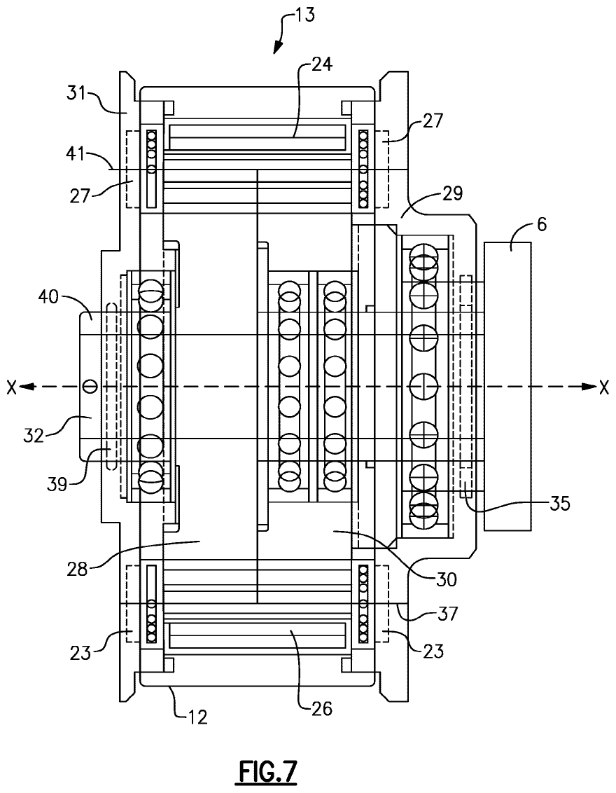

Referring now to FIGS. 5 through 7, the input ring gear 12 in conjunction with ring plates 29, 31 define the housing of gearbox 13. To effectively encapsulate the internal components of gearbox 13, ring plates 29, 31 are joined to input ring gear 12 via a series of bolts 8. A seal is created between ring gear 12 and ring plate 29 by the O-ring seal 36 and dynamic O-ring seal 35. On the opposite side, another seal is created between ring gear 12 and ring plate 31 by a second O-ring seal 33 and dynamic O-ring seal 39. It should be appreciated that the seals of input ring gear 12 may also be embodied as a shaft seal and dynamic shaft seal.

During construction of the gearbox 13, a volume of lubricant is placed in and around the gearbox's internal components. As such, when gearbox 13 rotates, lubricant is flung around (e.g. outward from output shaft 42 and the ball bearing rings 34) so as to self-lubricate the self-contained internal components of gearbox 13 and allow the internal components to remain continuously deposited with lubrication. This allows for a continuous operation of gear system 10, for example, without the need for certain routine, burdensome maintenance.

Within the central opening of input ring gear 12 are one or more balance gears or planet locking gears 24, 26, output spur gear 28, and fixed spur gear 30. Output spur gear 28 is rotatably mounted on drive shaft 32, in a radially inward, concentric relation to ring gear 12, and is in meshing engagement with planet locking gears 24, 26. Output spur gear 28 further includes output shaft 42, which is hollow to allow the output spur gear 28 to be mounted around drive shaft 32. Fixed spur gear 30 is fixedly mounted over output shaft 42 via mount paddle 6, adjacent to output spur gear 28 on the side thereof opposite ring plate 31. Fixed spur gear 30 is also in meshing engagement with planet locking gears 24, 26. One or more ball bearing rings 34 may be positioned on output shaft 42, in between output shaft 42 and fixed spur gear 30, to facilitate rotation of output spur gear 28 relative to fixed spur gear 30. An additional ball bearing ring 34 may be positioned on fixed spur gear 30 to facilitate rotation of gearbox 13 with respect thereto. In other gear system 10 embodiments, input ring gear 12 may extend in a perpendicular, spaced relation to drive shaft 32 (e.g. via miter gears).

The first and second planet locking gears 24, 26 are rotatably mounted within ring gear 12. Planet gears 24, 26 rotate about their own respective mounting axes 37, 41. Mounting axes 37, 41 are created by orifices 23, 27 in ring plates 29, 31, when the ring plates 29, 31 are mounted to ring gear 12. Second planet gear 26 is in 180° off-set relation with respect to first planet gear 24, about the full 360° circumference of ring gear 12. As shown, the planet locking gears 24, 26 generally comprise a smaller diameter than the spur gear 30. The planet gears teeth 24′, 26′ mesh with the spur gear teeth 28′, 30′ (shown in FIG. 8) causing planet gears 24, 26 to rotate about their respective mounting axes 37, 41 while being revolved around the 360° circumference of spur gears 28, 30 by ring gear 12. One or more planet gear ball bearing rings 19 may be positioned on planet gears 24, 26 to facilitate rotation of planet gears 24, 26 about mounting axes 37, 41.

Fixed spur gear 30 has N number of gear teeth 30′, shown as an involute form geometry. Output spur gear 28 has a substantially similar pitch diameter as the fixed spur gear 30 but with N+/−X number of gear teeth 28′ (e.g., two fewer teeth than the fixed spur gear 30), shown as a modified involute form geometry. In the simplest embodiment, the tooth orientation 28′ is involute with the spacing between teeth adjusted to take up the space from the removal of the 2 teeth. For example, the difference in tooth spacing for 53/51 teeth and approximately 8 inch diameter ring gear is approximately 0.008″ per tooth.

Orienting the output and fixed spur gear teeth 28′, 30′ in this manner forces gear teeth 28′, 30′ to substantially align at the point in which they meshingly engage with planet gear teeth 24′, 26′. However, beyond this point, gear teeth 28′, 30′ begin to separate until becoming fully separated at the point about the full 360° circumference of the spur gears 28, 30 furthest from where meshing engagement occurs. For example, when gearbox 13 comprises two planet gears 24, 26, the point of furthest gear teeth 28′, 30′ separation occurs at the two locations about the full 360° circumference directly between both points where meshing engagement takes place.

Since output spur gear 28 has 2 fewer teeth and fixed spur gear 30 remains stationary, each revolution of the planet gears 24, 26 about the 360° circumference of fixed spur gear 30 yields a rotational advancement of output spur gear 28 by 2 teeth. As follows, rotation of shaft 20 causes rotation of ring gear 12 which causes rotation of planet gears 24, 26 which therefore cause rotation of output spur gear 28 which ultimately causes rotation of drive shaft 32. It is appreciated that the tooth numbers and ratios listed above are an example and are therefore not to be construed as limiting the invention. It will be further appreciated that the gearing concept may be scaled up or down in size of gears, number of gear teeth, number of gears, and/or gear configuration.

FIG. 8 is a schematic diagram illustrating the basic relationship between the output and fixed spur gears 28, 30, respectively, with respect to planet locking gears 24, 26. When rotational force is applied directly to output spur gear 28 via output shaft 42, the gear will create an “Applied Load” force to rotate planet gears 24, 26 on fixed spur gear 30. However, since fixed spur gear 30 is fixed, it will create an equal, countervailing “Reacted Load” force against such a rotation. With “Applied Load” and “Reacted Load” forces being applied on both sides, planet gear teeth 24′, 26′ become frictionally wedged in between the fixed and output spur gear teeth 28′, 30′, causing planet gears 24, 26 to lock in place. Once locked, planet gear teeth 24′, 26′ will halt the rotational advancement of output spur gear 28. Additionally, when the general configuration comprises 2 planet gears 180 degrees apart, any gear twisting (due to shear action between gear teeth) will be in equal and opposite directions on each planet gear and become neutralized. Back rotation of gearbox 13 is therefore only made possible through a force of backward rotation made directly to ring gear 12. If a cable connecting a load to the winch 15 happens to break, for example, gearbox 13 will not be able to back drive and allow any portion of the cable to retreat back into winch 15.

Planetary drive configurations can also be noisy due to sliding and scuffing between the teeth of the output and fixed spur gears 28′, 30′ and those of the planet gears 24′, 26′. Undue friction is created when output spur gear teeth wedge the planet gear teeth, discussed above. To reduce such sliding, scuffing, and undue friction, the output and fixed spur gear teeth 28′, 30′ and planet gear teeth 24′, 26′ are configured to comprise an angularly complimenting, noise-dampening pressure angle 46 (also known as the “angle of obliquity”).

While the pressure angles of most common stock gears are around 141/2°, 20°, or 22°, the output and fixed gear pressure angles are most preferably made to be approximately 35°. This pressure angle configuration provides for lower backlash, smoother operation, and less sensitivity to manufacturing flaws. More specifically, the larger angles allow for the fixed and output spur gear teeth 28′, 30′ to slide easily in between the planet gear teeth 24′,26′ with more rolling and less scuffing than previous pressure angles. This may also generally be accomplished by larger pressure angles that range from approximately 20° to 45°.

FIGS. 9-12 show alternate embodiments of connection between the motor 16 and primary input gear 12.

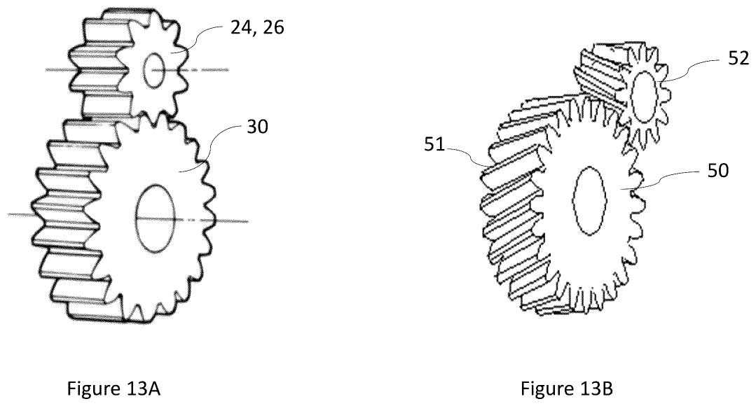

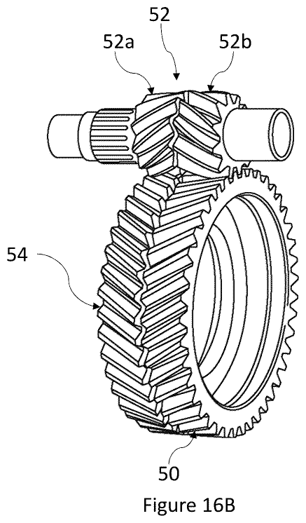

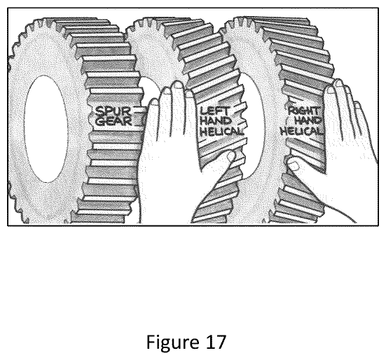

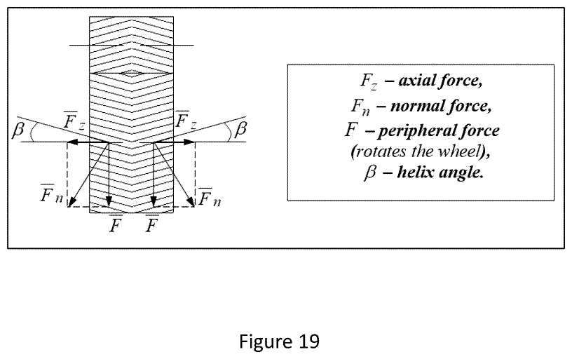

Referring to FIGS. 13A-22, an alternate embodiment of the output ring gear system includes one or more helical gears 52, 50 or helical gear pairs in addition to or instead of the previously described (FIG. 13A) straight toothed (zero helix angle gear) balance gears or planet locking gears 24, 26 and spur gears 30, respectively. Referring to FIGS. 16A-B, in some embodiments, helical gear 50a comprises a helical fixed gear, helical gear 52b comprises a helical output gear, and helical gear 52 comprises a helical balance gear. Helical gears, such as those shown in FIG. 13B, are another type of cylindrical gear and comprise a plurality of gear teeth 51 in a helix configuration (i.e., an infinite spiral). Accordingly, helical gears comprise a non-zero helix angle β (FIG. 19) and may be oriented either in a left-hand or a right-hand configuration as shown in FIG. 17. Helical gears increase the meshing surface area between gears (i.e., the portion of each gear tooth that interacts with a corresponding gear tooth). As shown specifically in FIGS. 15 and 16, at any given position of gear 52b, at least a portion of two gear teeth 52b1, 52b2 are fully engaged with a corresponding adjacent gear 50b. This increased engagement between corresponding helical gears 50a, 50b and 52a, 52b may increase the lifetime of the gear and lead to smoother operation of the output ring gear system with less vibration. In addition, the cross-section of the helical gear teeth may be similar to those shown in FIG. 8 such that the teeth of the fixed helical gear 50a and the teeth of the output helical gear 50b comprise a noise-dampening pressure angle configuration which angularly compliments the teeth of the at least one helical balance gear 52.

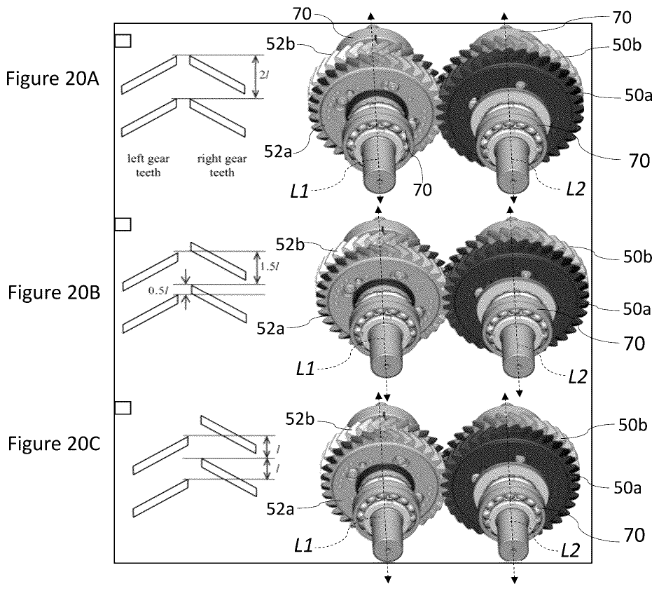

Referring to FIGS. 20A-C, helical gears 50a, 50b produce a thrust load in opposing directions along their axis of rotation L1, L2 as a function of the applied torque. A bearing 70 that is configured to accommodate axial thrust loading may be used to counter the generated thrust load generated by the driving force of the gears 50a, 50b. In a case where the torque load is applied in both rotational directions (i.e. bi-directional loading) there may be a need for more than one bearing 70 to be positioned such that the bearing(s) can accommodate the predicted thrust force in both axial directions along the axis of rotation L1, L2. In one example, the bearings 70 may be placed in front of and behind the helical gear, such as proximate to each of the driving force gears 50a, 50b or the balance gears 52a, 52b. The gear system of claim 1, further comprising at least one bearing positioned proximate to the at least one helical balance gear and configured to counter an axial thrust load generated by the at least one helical balance gear. In some embodiments, at least one bearing positioned proximate to the helical output gear 50b and is configured to counter an axial thrust load generated by the helical output gear 50b.

However, as shown in FIGS. 13B, 15, 16, 18 and 20A-C, helical gears 50a, 50b, 52a, 52b of which opposite orientation (left and right-handed) are used to counter (reduce) or cancel the generated thrust force from helical mesh with that of another helical gear. In some embodiments, the first gear portion 52a comprises a first plurality of gear teeth arranged in a first orientation and the second gear portion 52b comprises a second plurality of teeth arranged in a second orientation that is different than the first orientation. In some embodiments, the first orientation and the second orientation comprise one of a right-hand orientation and a left-hand orientation.

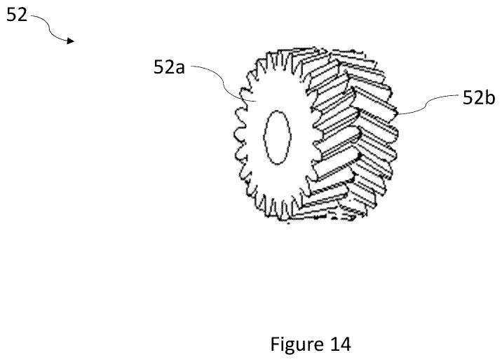

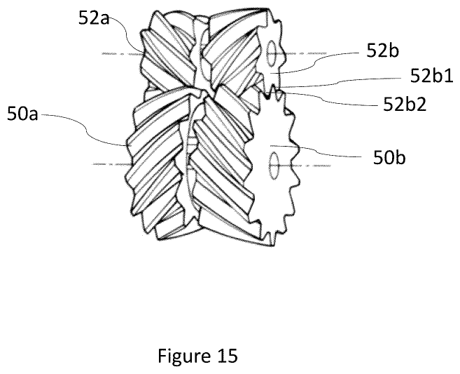

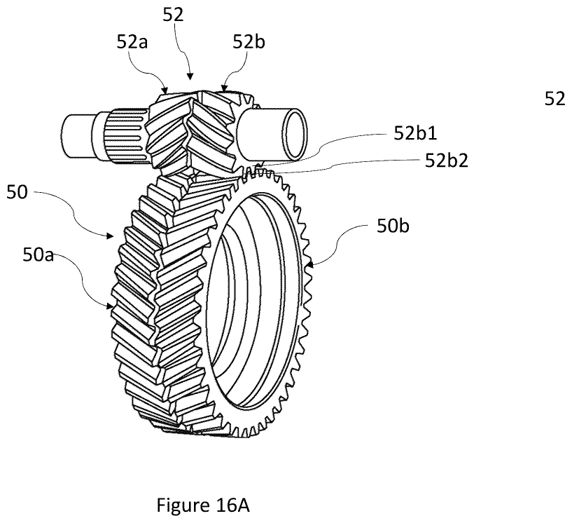

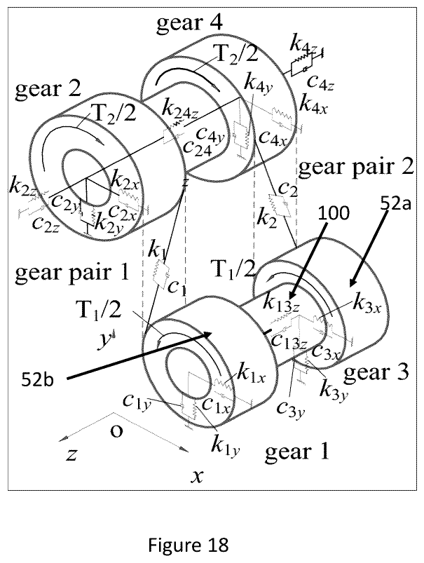

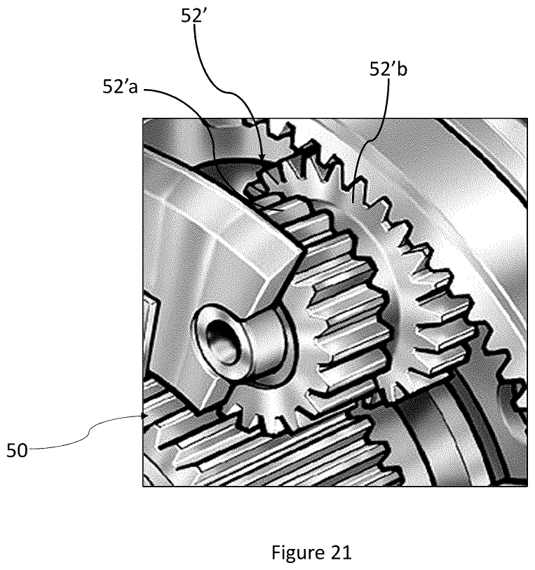

For example, FIGS. 18 and 19 are vector force representations of two helical gears working to cancel thrust force as a function of applied torque. One or more of the planet locking gears or balance gears 24, 26, 52 disclosed may be produced as a single gear with multiple portions, each specifically configured to interact with a corresponding mating gear, such as 30, 50. For example, balance gear 52 may include a first balance gear portion 52a and a second balance gear portion 52b, which may be formed as a single unitary gear with each gear portion 52a, 52b configured to interact with a corresponding output helical gear 50 or output helical gear portions 50a, 50b, respectively. Similarly, and as shown in FIGS. 14, 16, and 20A-C, the first balance gear portion 52a and the second balance gear portion 52b may be formed separately and coupled together such that rotate as one balance gear. The drive gears or output helical gear 50 may be formed in a same manner such that they include a first output gear portion 50a and a second output gear portion 50b. As shown, the first gear portion 52a and the second gear portion 52b are similarly sized, however another embodiment of a planet locking gear 52′ is shown in FIG. 21 where the first gear portion 52′ and the second gear portion 52′b are differently sized relative to each other and may comprise a different number/configuration of teeth relative to each other. In some embodiments, the first gear portion 52′a comprises a first diameter and the second gear portion 52′b comprises a second diameter that is different than the first diameter. Forming the planet locking gears 52, 52′ to include a first gear portion 52a, 52′a and a second gear portion 52b, 52′b enables the speed ratio across the output ring gear system to be specifically tailored.

In some embodiments, the fixed helical gear 54 (FIG. 16B) of the output ring gear system defines a fixed gear diameter and the output helical gear 50 (FIG. 16B) comprises an output gear diameter that is different from the fixed gear diameter. In some embodiments, the fixed helical gear 54 is configured to engage one of the first and second gear portions 52a, 52′a, 52b, 52′b of the at least one balance helical gear 52′. In some embodiments, and the output helical gear 50 is configured to engage another of the first and second gear portions 52′a, 52′b of the at least one helical balance gear 52′ (FIG. 21).

The balance gear 52 may further include a modifying device 100 positioned between the first gear portion 52a and the second gear portion 52b to provide additional functionality. For example, the modifying device 100 (FIG. 18) may be a buffering clutch configured to smooth gear engagement. The addition of the modifying device 100 between the input and fixed gears and/or between each end of the balance gears 24, 26, 52 enables a buffer or a ‘soft start’ capability to the disclosed output ring gear system. In some embodiments, the soft start temporarily reduces the load and the torque applied to the helical gears.

In an embodiment, a “scissor” is constructed by placing a spring-like material or device between two gears that are in mesh simultaneously with the driving pair mate. In doing so, the two gears of the combined scissor gear are slightly out of phase with each other and as such reduce or eliminate gear train backlash. The modifying device 100 (e.g. elastomer or spring) would work to smooth the engagement of the of the output ring gear system much like the clutch in a vehicle equipped with a manual transmission, or to provide the functionality of a synchronizer in same said transmission. As shown, the modifying device 100 can absorb the stepwise input energy from the input gear 12 and dissipate said energy over time to provide a smooth transition from one energy state (e.g. input torque multiplied by the input rotational speed) to another energy state while still providing the ability to lock in the non-drive state of operation.

It should be appreciated that the gears, shafts, and housings of the output ring gear system 10 may be made from, but are limited to, metals, plastics, composites, ceramics, woods, plywood, castings, metal powders, metal or plastic extrusions, or punched blanks. The various components of the output ring gear system 10 may be manufactured by, for example, laser cutting processes, water jet cutting processes, punch and die, fine-blanking, roll forming, investment cast, or laminated layers of materials (e.g. sheet metal, plastic, paper), or 3D printing processes.

While the invention has been described with reference to preferred embodiments, it will be understood by those skilled in the art that various changes may be made, and equivalents may be substituted for elements thereof to adapt to particular situations without departing from the scope of the invention. Therefore, it is intended that the invention is not limited to the particular embodiments disclosed as the best mode contemplated for carrying out this invention, but that the invention will include all embodiments falling within the scope and spirit of the appended claims.

1. (canceled)

2. The gear system of claim 5, wherein the at least one helical balance gear comprises a first gear portion and a second gear portion.

3. The gear system of claim 4, wherein the first gear portion comprises a first plurality of gear teeth arranged in a first orientation and the second gear portion comprises a second plurality of teeth arranged in a second orientation that is different than the first orientation, wherein the first orientation and the second orientation comprise one of a right-hand orientation and a left-hand orientation.

4. A self-locking non-backdrivable gear system comprising:
a gearbox;
a primary motor input; and
a drive shaft extending along an axis and operatively coupled to the primary motor input, the drive shaft configured to drive a rotation of the gearbox about the axis of said drive shaft;
the gearbox comprising:
an input ring gear mounted around said drive shaft and positioned in rotational engagement with the primary motor input;
a ring plate and seal configuration mounted to the input ring gear and configured for sealing components within the input ring gear;
at least one helical balance gear rotatably mounted within the input ring gear and configured to rotate about a mounting axis, wherein the at least one helical balance gear is further configured to rotate with the input ring gear and comprises a first gear portion and a second gear portion, wherein the first gear portion comprises a first diameter and the second gear portion comprises a second diameter that is different than the first diameter;
an output helical gear rotatably mounted within the input ring gear in a radially inward, concentric relation to the input ring gear, wherein the output helical gear comprises a first predetermined number of gear teeth in meshing engagement with the at least one helical balance gear;
an output shaft connected to the drive shaft;
a fixed helical gear fixedly mounted around the output shaft and positioned adjacent to the output helical gear, wherein the fixed helical gear comprises a second predetermined number of gear teeth in meshing engagement with the at least one helical balance gear, wherein the first predetermined number and the second predetermined number are different; and
wherein the teeth of the fixed helical gear and the output helical gear engage oppositely oriented teeth of the at least one helical balance gear,
wherein rotation of the primary motor input causes rotation of the input ring gear, which causes rotation of the at least one helical balance gear which causes rotation of the output helical gear which causes rotation of the drive shaft, and
wherein in the absence of rotation of the input ring gear, a rotational force applied to the output helical gear forces the teeth of the fixed and output helical to lock the at least one helical balance gear in place.

5. A self-locking non-backdrivable gear system comprising:
a gearbox;
a primary motor input; and
a drive shaft extending along an axis and operatively coupled to the primary motor input, the drive shaft configured to drive a rotation of the gearbox about the axis of said drive shaft;
the gearbox comprising:
an input ring gear mounted around said drive shaft and positioned in rotational engagement with the primary motor input;
a ring plate and seal configuration mounted to the input ring gear and configured for sealing components within the input ring gear;
at least one helical balance gear rotatably mounted within the input ring gear and configured to rotate about a mounting axis, wherein the at least one helical balance gear is further configured to rotate with the input ring gear;
an output helical gear rotatably mounted within the input ring gear in a radially inward, concentric relation to the input ring gear, wherein the output helical gear comprises a first predetermined number of gear teeth in meshing engagement with the at least one helical balance gear;
an output shaft connected to the drive shaft;
a fixed helical gear fixedly mounted around the output shaft and positioned adjacent to the output helical gear, wherein the fixed helical gear comprises a second predetermined number of gear teeth in meshing engagement with the at least one helical balance gear, wherein the first predetermined number and the second predetermined number are different; and
wherein the teeth of the fixed helical gear and the output helical gear engage oppositely oriented teeth of the at least one helical balance gear,
wherein rotation of the primary motor input causes rotation of the input ring gear, which causes rotation of the at least one helical balance gear which causes rotation of the output helical gear which causes rotation of the drive shaft, and
wherein in the absence of rotation of the input ring gear, a rotational force applied to the output helical gear forces the teeth of the fixed and output helical to lock the at least one helical balance gear in place,
wherein the fixed helical gear comprises a fixed gear diameter and the output helical gear comprises an output gear diameter that is different from the fixed gear diameter.

6. The gear system of claim 6, wherein the fixed helical gear is configured to engage one of the first and second gear portions of the at least one balance helical gear, and wherein the output helical gear is configured to engage another of the first and second gear portions of the at least one helical balance gear.

7. (canceled)

8. The gear system of claim 3, wherein teeth of the fixed helical gear and teeth of the output helical gear comprise a noise-dampening pressure angle configuration which angularly compliments the teeth of the at least one helical balance gear.

9. The gear system of claim 4, further comprising a modifying device positioned between the first gear portion and the second gear portion.

10. A self-locking non-backdrivable gear system comprising:
a gearbox;
a primary motor input;
a drive shaft extending along an axis and operatively coupled to the primary motor input, the drive shaft configured to drive a rotation of the gearbox about the axis of said drive shaft; and
a modifying device;
the gearbox comprising:
an input ring gear mounted around said drive shaft and positioned in rotational engagement with the primary motor input;
a ring plate and seal configuration mounted to the input ring gear and configured for sealing components within the input ring gear;
at least one helical balance gear rotatably mounted within the input ring gear and configured to rotate about a mounting axis, wherein the at least one helical balance gear is further configured to rotate with the input ring gear and comprises a first gear portion and a second gear portion;
an output helical gear rotatably mounted within the input ring gear in a radially inward, concentric relation to the input ring gear, wherein the output helical gear comprises a first predetermined number of gear teeth in meshing engagement with the at least one helical balance gear;
an output shaft connected to the drive shaft;
a fixed helical gear fixedly mounted around the output shaft and positioned adjacent to the output helical gear, wherein the fixed helical gear comprises a second predetermined number of gear teeth in meshing engagement with the at least one helical balance gear, wherein the first predetermined number and the second predetermined number are different; and
wherein the teeth of the fixed helical gear and the output helical gear engage oppositely oriented teeth of the at least one helical balance gear,
wherein rotation of the primary motor input causes rotation of the input ring gear, which causes rotation of the at least one helical balance gear which causes rotation of the output helical gear which causes rotation of the drive shaft, and
wherein in the absence of rotation of the input ring gear, a rotational force applied to the output helical gear forces the teeth of the fixed and output helical to lock the at least one helical balance gear in place,
wherein the modifying device is positioned between the first gear portion and the second gear portion and comprises a buffering clutch configured to smooth gear engagement.

11. The gear system of claim 4, further comprising at least one bearing positioned proximate to the at least one helical balance gear and configured to counter an axial thrust load generated by the at least one helical balance gear.

12. The gear system of claim 4, further comprising at least one bearing positioned proximate to the helical output gear configured to counter an axial thrust load generated by the helical output gear.

13. The gear system of claim 4, wherein the gearbox comprises a self-lubricating gearbox including a volume of lubricant sealed within the gearbox.

14. The gear system of claim 10, wherein the first gear portion comprises a first plurality of gear teeth arranged in a first orientation and the second gear portion comprises a second plurality of teeth arranged in a second orientation that is different than the first orientation, wherein the first orientation and the second orientation comprise one of a right-hand orientation and a left-hand orientation.

15. The gear system of claim 10, wherein teeth of the fixed helical gear and teeth of the output helical gear comprise a noise-dampening pressure angle configuration which angularly compliments the teeth of the at least one helical balance gear.

16. The gear system of claim 10, wherein the first gear portion comprises a first diameter and the second gear portion comprises a second diameter that is different than the first diameter.

17. The gear system of claim 10, wherein the first gear portion and the second gear portion comprise similar diameters.

18. The gear system of claim 10, wherein the fixed helical gear comprises a fixed gear diameter and the output helical gear comprises an output gear diameter that is different from the fixed gear diameter.

19. The gear system of claim 18, wherein the fixed helical gear is configured to engage one of the first and second gear portions of the at least one balance helical gear, and wherein the output helical gear is configured to engage another of the first and second gear portions of the at least one helical balance gear.

20. The gear system of claim 10, further comprising at least one bearing positioned proximate to the at least one helical balance gear and configured to counter an axial thrust load generated by the at least one helical balance gear.

21. The gear system of claim 10, further comprising at least one bearing positioned proximate to the helical output gear configured to counter an axial thrust load generated by the helical output gear.

22. The gear system of claim 9, wherein the modifying device comprises a buffering clutch configured to smooth gear engagement.
